(19) United States
(12) Patent Application Publication
(10) Pub. No.: US 2026/0327160 A1
(43) Pub. Date: Oct. 22, 2026

(54) Composting Plans and Method for Compost Production

(71) Applicant: Michael Niederbacher, Bruneck (IT)

(72) Inventor: Michael Niederbacher, Bruneck (IT)

(21) Appl. No.: 19/109,430

(22) PCT Filed: Sep. 6, 2022
(86) PCT No.: PCT/EP2022/074754

§ 371 Date: Mar. 6, 2025

(51) Int. Cl. C05F 17/971; C05F 3/06; C05F 5/00; C05F 17/70; C05F 17/943; C05F 17/993; C05G 5/20

(52) U.S. Cl. CPC C05F 17/971; C05F 3/06; C05F 5/002; C05F 17/70; C05F 17/943; C05F 17/993; C05G 5/20

(57) ABSTRACT

The invention relates to a composting plant (1) with a structural material bed formed by organic structural material, for example straw. Furthermore, the composting plant has at least one distribution system (18) for an organic fermentation product (33) and for a dosing material (43) which differs from the organic fermentation product, it being preferably provided that the dosing material is suitable and/or designed to fix or bind molecular nitrogen. Furthermore, a control and/or regulating device is provided, by means of which the at least one distribution system (18) can be controlled in order to distribute organic fermentation product (33) at defined times in a defined quantity and/or dosing material (43) at defined times in a defined quantity on and/or in the structural material bed (6) in a controlled manner.

The invention relates to a composting plant according to the preamble of claim 1 and a method for composting production according to the preamble of claim 36.

A known composting plant has an upwardly open composting basin as a composting container, into which straw is introduced as organic structural material in the form of a structural material bed. Liquid manure is then applied to this bed as liquid organic fermentation materials. With a composting plant of this type, it is possible to produce compost using liquid manure with an advantageous volume reduction and manure utilization. With this type of compost production, however, some components, such as nitrogen, which are important for compost production, escape, so that the compost quality is comparatively low and the economic marketing of compost produced in this way is impaired. In addition, environmentally harmful substances such as NH3 (ammonia) and N2O (nitrous oxide) also escape.

The object of the invention is therefore to create a composting plant and a method for producing compost with which compost of a high quality can be produced.

This object is solved with the features of the independent patent claims. Preferred embodiments are part of the subclaims

According to claim 1, a composting plant with a structural material bed comprising an organic structural material is provided.

Furthermore, at least one distribution system is provided for an organic fermentation material and for a dosing material which differs from the organic fermentation material. It is preferably provided that the dosing material is suitable and/or designed to fix or bind volatile and/or leaching compounds and thus to hold them in the structural material bed, during and when the dosing material is applied to introduced into the structural material bed.

The term “volatile and/or leaching compound” is to be understood here expressly in a broad sense and is intended to include any liquid and/or gaseous compound and, where appropriate, any pure liquid and/or gaseous substance which is or is intended to be retained in a fertilizer but which is exposed to the risk of being lost in the course of the composting technique described herein. Preferably, the volatile and/or leaching compounds are nitrogen-containing compounds, preferably ammonia (NH3) and/or ammonium (NH4+) and/or nitrous oxide (N2O), and/or phosphorus-containing compounds, preferably phosphorus pentoxide (P205), and/or potassium-containing compounds, preferably potassium oxide (K2O), and/or magnesium-containing compounds, preferably magnesium oxide (MgO), and/or sulphur-containing compounds, preferably sulphur sulphate (SO4 2—).

Furthermore, a control and/or regulating device is provided, by means of which the at least one distribution system can be controlled in order to distribute organic fermentation material at defined times in a defined quantity and/or dosing material at defined times in a defined quantity on and/or in the structural material bed. In principle, this can be done in different ways, for example in such a way that the organic fermentation material and the dosing material are dosed onto and/or into the structural material bed one after the other, overlapping in time or together (as a fermentation material-dosing material mixture).

With the composting plant according to the invention, in addition to the organic fermentation material, the structural material bed is also supplied with a dosing material suitable in particular for defined additive binding, preferably mixed with the organic fermentation material in a predeterminable ratio, whereby a significant improvement in the compost quality of the compost is achieved. With the solution according to the invention, not only can a very good compost quality be achieved, but environmentally harmful emissions of polluting substances, such as NH3 (ammonia) and N2O (nitrous oxide), can also be reduced or minimized.

Preferably, the organic structural material is introduced into a composting basin, which is preferably open at the top, to form the structural material bed. At this point, however, it should be expressly mentioned that the term composting basin is to be understood here in an expressly broad and comprehensive manner and ultimately also includes any surface or plate on which a structural material bed rests. This means that the composting basin can have a basin or trough shape, but does not have to. For example, the composting basin may have no end walls and side walls, but only a support surface, or the composting basin may have no end walls and only side walls, to name just one further example.

According to a particularly preferred specific embodiment, it is provided that the at least one distribution system (viewed in the vertical axis direction) can be moved above the structural material bed, and preferably can be moved above the structural material bed in a controlled manner by means of the at least one control and/or regulating device. In the case of large-volume composting basins, this ensures that the distribution system has a relatively slim design and can be moved to any desired position in a targeted and controlled manner. A complex distribution system covering the entire composting basin can therefore be dispensed with in this case.

Specifically, the at least one distribution system can be connected or connectable to at least one fermentation material reservoir for organic fermentation material, from which organic fermentation material can be transferred to the distribution system. Furthermore, the at least one distribution system can also be connected or connectable to at least one dosing material reservoir for dosing material, from which dosing material can be transferred to the distribution system. This ensures that the substances to be added are always available in sufficient quantities, thus ensuring reliable operation of the system. For this purpose, at least one conveying device can advantageously be provided, by means of which organic fermentation material can be conveyed from the at least one fermentation material reservoir and from the at least one dosing material reservoir to the distribution system. This enables a functionally reliable supply of the materials and substances to be added. A specific embodiment is particularly advantageous here, in which, for example, at least one fermentation material conveying device is provided, by means of which organic fermentation material can be conveyed from the at least one fermentation material reservoir to the distribution system, and in which, furthermore, at least one dosing material conveying device is also provided, by means of which dosing material can be conveyed from the at least one dosing material reservoir to the distribution system. This enables targeted, advantageous dosing of the respective materials at the desired times in a simple and functionally reliable manner.

The at least one control and/or regulating device is preferably suitable and designed to move the distribution system (viewed in the vertical axis direction) above the structural material bed in a controlled manner and simultaneously convey organic fermentation material from the at least one fermentation material reservoir in a controlled manner by means of the at least one fermentation material conveying device and/or dosing material from the at least one dosing material reservoir in a controlled manner by means of the at least one dosing material conveying device. Such controlled dosing enables a targeted and controlled mode of operation of the system, with which the organic fermentation material and the dosing material can be dosed onto and/or into the structural material bed one after the other, overlapping in time or together (as a fermentation material-dosing material mixture).

According to a particularly preferred, compact and structurally less complex embodiment, preferably only a single distribution system is provided, which forms both the distribution system for organic fermentation materials and for dosing materials. However, depending on the specific design of the composting plant and in particular the size of the composting basin, a separate distribution system may also be provided for organic fermentation material and dosing material.

According to a first specific embodiment for this purpose, for example, a mixing device can be provided upstream of the at least one distribution system, in which the dosing material can be added to the organic fermentation material locally upstream and thus in advance of the supply of the organic fermentation material to the at least one distribution system in a predetermined ratio controlled, so that a fermentation material-dosing material mixture is already supplied or can be supplied to the at least one distribution system. However, with certain dosing materials, for example when adding kieserite, this embodiment variant can possibly lead to problems in that the lines in the distribution system clog too quickly.

In order to counter this problem, it can therefore also be provided as an alternative that the at least one distribution system, preferably the only distribution system, has or forms a mixing device which is suitable and designed to add the dosing material to the organic fermentation material in a controlled manner in a predeterminable ratio before, preferably immediately before, and/or during the application of the organic fermentation material, and thus to distribute a fermentation material-dosing material mixture on and/or in the structural material bed. In this embodiment, the mixing device is thus arranged in an integral and compact design on the distribution system or formed by it, so that the dosing material can be mixed with the organic fermentation material in the distribution system in a predetermined ratio in a controlled manner. The mixing device can be arranged here at any suitable location, but is preferably arranged at the outlet of the distribution system or, alternatively, at the inlet of the distribution system.

Alternatively, it can also be provided that the separate distribution systems for organic fermentation material and dosing material are suitable and designed to distribute dosing material and organic fermentation material separately on and/or in the structural material bed.

In particular for a simple and advantageous movement of the distribution system above the structural material bed, it is advantageous if the at least one distribution system has at least one distribution traverse which spans the composting basin and/or the structural material bed at least partially, preferably completely, above the structural material bed and which can be moved above the structural material bed in a controlled manner by means of the at least one control and regulating device. A traverse is understood here in particular to be a mechanical support on which components can be held or arranged. Here too, for example, only a single distribution traverse can be provided for a compact design, which has the only distribution system. Alternatively, several distribution traverses can also be provided, each of which has a distribution system.

In principle, the at least one distribution traverse can be arranged in any way above the composting basin or above the structural materials bed, for example suspended and supported on a support structure spanning the composting basin, for example suspended or supported in the manner of a trolley along at least one carrier. The at least one support can be stationary or movable. Such a spanning structure may, for example, be a roof structure spanning and covering the composting basin. According to a particularly preferred specific embodiment, however, the distribution traverse is intended to be supported on side walls of the composting basin and to move along them. For this purpose, the composting basin has one, preferably plate-shaped, bottom wall and two vertical, preferably parallel, side walls that delimit the bottom wall laterally and in the direction of travel of the distribution traverse. In this way, the at least one distribution traverse can be supported on both sides on longitudinal guide rails with guide elements on the side walls in a robust, simple and space-saving manner and can be moved along the side walls in a controlled manner.

In principle, the at least one dosing material reservoir can not be part of the distribution system and/or can be arranged stationary outside the composting basin, so that the at least one dosing material reservoir is connected to the distribution system by means of a pipe and/or line connection, preferably permanently and/or lockable. The at least one dosing material reservoir can, for example, be connected to the distribution system via at least one hose and/or pipe line, whereby the hose and/or pipe line then preferably has a length that takes into account and follows the travel path of the distribution system. Overall, however, this is very complex in terms of manufacturing technology and design, so that according to a particularly preferred embodiment of the present inventive idea, it is provided that the at least one dosing material reservoir forms part of the distribution system, preferably the at least one dosing material reservoir is arranged on the distribution system, most preferably the at least one dosing material reservoir is arranged on the distribution traverse so as to be movable with it. Further, at least one, preferably stationary, dosing material storage reservoir, preferably a storage tank, can then be provided in the area outside the composting basin and the distribution system, which can be moved above the structural material bed, can be arranged in the area of the at least one dosing material storage reservoir, preferably at a longitudinal end of the composting basin, then have a controllable stop at which the dosing material reservoir, which can be moved along with the distribution system, can be filled from the at least one associated dosing material storage reservoir, preferably by means of at least one filling line which can be coupled to the dosing material reservoir. The at least one dosing material storage reservoir, which is preferably larger than the dosing material reservoir that can be moved along with the distribution system, can, for example, be arranged laterally next to or above the composting basin as viewed in the vertical axis direction.

The above description of the at least one dosing material reservoir also applies in a figurative sense to the at least one fermentation material reservoir:

Thus, the at least one fermentation material reservoir can also not be part of the distribution system and/or be arranged stationary outside the composting basin, so that the at least one fermentation material reservoir is connected to the distribution system by means of a pipe and/or line connection, preferably permanently and/or lockable.

The fermentation material reservoir can, for example, simply be formed by a channel that runs along one or more sides of a composting basin and in which the organic fermentation material is contained. Alternatively, the fermentation material reservoir can also be formed in another way, for example by a storage container that is connected to the distribution system via at least one hose and/or pipe line, whereby the hose and/or pipe line then preferably has a length that takes into account and follows the travel path of the distribution system. This can be done, for example, by means of a hose reel that has a hose that can be wound and unwound. The hose reel or reel can be arranged on the distribution system, for example on the distribution traverse. The winding and unwinding of the hose can be easily adapted to the respective travel path of the distribution system or, in this specific case, to the travel path of the distribution traverse, so that the entire hose does not have to be unwound each time. For this reason, according to a particularly preferred embodiment, it is provided that the hose is a dimensionally stable hose that can be rolled up and unrolled, which can pass the liquid organic fermentation materials, for example liquid manure, both when rolled up and when unrolled.

In principle, however, it could also be provided, alternatively or additionally, that the at least one or at least one fermentation material reservoir forms part of the distribution system, preferably the at least one or at least one fermentation material reservoir is arranged on the distribution system, most preferably the at least one or at least one fermentation material reservoir is arranged on the distribution traverse so as to be movable therewith. In particular in conjunction with such a fermentation material storage reservoir arranged on the distribution system, at least one, preferably stationary, fermentation material storage reservoir, preferably a storage tank, can then be provided in the area outside the composting basin and the distribution system, which can be moved above the structural material bed, can be arranged in the area of the at least one fermentation material storage reservoir, preferably at a longitudinal end of the composting basin, then have a controllable stop at which the fermentation material reservoir, which can be moved along with the distribution system, can be filled from the at least one associated fermentation material storage reservoir, preferably by means of at least one filling line which can be coupled to the fermentation material reservoir. The at least one fermentation material storage reservoir, which is preferably larger than the fermentation material reservoir that can be moved along with the distribution system, can be arranged here, for example, laterally next to or above the composting basin as viewed in the vertical axis direction.

A particularly simple and functionally reliable distribution of the materials to be fed onto the fill is achieved with a distribution system designed as a distribution pipe system, which has at least one, preferably exactly one, outflow pipe extending over at least part of the length of the distribution traverse with at least one, preferably one, outflow pipe with a plurality of outflow devices, preferably outflow openings, spaced apart from one another in the longitudinal direction. Alternatively, however, the distribution traverse can also be formed by at least one, preferably exactly one, outflow pipe with at least one outflow device, preferably by an outflow pipe with a plurality of outflow devices, preferably outflow openings, spaced apart from one another in the longitudinal direction. In a particularly easy-to-manufacture embodiment, the outflow devices can be formed by holes and/or slots, but optionally by channel-shaped overflows.

The distribution system preferably has at least one mixing and stirring element engaging in the structural material bed, preferably several mixing and stirring elements spaced apart from one another and engaging in the structural material bed. Furthermore, it may preferably be provided that at least one mixing and stirring element, preferably several mixing and stirring elements spaced apart from one another and engaging in the structural material bed, is or are arranged on the distribution system, preferably on the distribution traverse, most preferably on the outflow pipe of the distribution system designed as a distribution pipe system. For example, a plurality of mixing and stirring elements which are spaced apart from one another, for example aligned downwards in the vertical axis direction and engaging in the structural material bed, can be arranged on the distribution system or the distribution traverse and are designed, for example, as mixing and stirring elements which can be moved downwards and/or laterally in the vertical axis direction and can be driven in rotation in a controlled manner. The at least one mixing and stirring element is preferably designed as a mixing screw and/or mixing paddle. With such mixing and stirring elements, the structural material bed can be loosened and mixed as required using the distribution traverse.

According to a preferred embodiment, the distribution system or preferably the outflow devices are at least partially suitable and designed to apply dosing material and organic fermentation material or a fermentation material-dosing material mixture directly to the at least one mixing and stirring element, preferably to spray or spray it directly onto the at least one mixing and stirring element. This allows a very compact design to be realized and distribution can also take place quickly without unnecessary loss of time.

The composting plant can be operated in batch mode and the compost produced can then be discharged from the composting basin after the desired composting time. This can lead to undesirable downtimes, particularly with large or multiple composting plants. As an alternative to batch operation, the composting plant can therefore also be operated in continuous throughput mode. For this purpose, the composting plant preferably has a feed device by means of which the structural material bed, preferably controlled via the control and/or regulating device, can be moved along a feed device through the composting basin, with the feed rate preferably being 1 to 5 meters per day, most preferably 1 to 3 meters per day. A drying device and/or a pelletizing device may then be provided at the end of the conveying path.

The feed device can be formed by a conveyor floor, in particular in the form of a conveyor belt, and/or by at least one screw conveyor. A particularly preferred embodiment here is one in which the at least one screw conveyor is formed by a screw conveyor that simultaneously forms the mixing and stirring element, as described above. In other words, the at least one screw conveyor is formed by a mixing and stirring element engaging in the structural material bed, which is preferably arranged on the distribution system, most preferably on the distribution traverse or on the outflow pipe of the distribution system designed as a distribution pipe system. In order to achieve the desired feed rate, the at least one screw conveyor, viewed in the conveying direction, is inclined towards the vertical, preferably inclined forwards in the corresponding direction of rotation towards the vertical. A structure in which two screw conveyors form a screw conveyor pair in the manner of a twin-screw extruder is particularly preferred for an effective feed rate, whereby it is preferable that several screw conveyor pairs are provided at a distance from one another.

Uniform distribution of the fermentation material with the added dosing material onto and/or into the structural material bed over the entire length and width of the composting basin is essential for the high quality of the compost produced. For an even application of the fermentation material with the dosing material, a distribution pipe system can therefore also be provided as a distribution system, which has several pipe branches. According to a particularly preferred specific embodiment, a structure is proposed in which the distribution pipe system has a main pipe that is connected to the outflow pipe via a piping system that branches out, preferably several times.

The concrete implementation of such a particularly advantageous embodiment with a main pipe and an outflow pipe connected thereto via a branched piping system can be realized here, for example, in such a way that the main pipe is routed up to approximately the middle of the distribution traverse up to a first pipe branch, at which an intermediate pipe branches off, which extends with a first intermediate pipe part back in the direction of the main pipe up to a second pipe branch and with a second intermediate pipe part in the direction away from the main pipe up to a third pipe branch, wherein at the second pipe branch the main pipe is routed up to approximately the middle of the distribution traverse up to a first pipe branch. back in the direction of the main pipe as far as a second pipe branch and with a second intermediate pipe part in the direction away from the main pipe as far as a third pipe branch, a longitudinal pipe being connected to the second pipe branch and to the third pipe branch in each case. In relation to the longitudinal direction of the distribution traverse, these longitudinal pipes extend over a left- and right-sided section of the distribution traverse, preferably over approximately half to a third of the length of the distribution traverse. In addition, these two longitudinal pipes can each be connected to several standpipes, preferably several equally spaced standpipes, to the outflow pipe extending over the length of the distribution traverse above the structural material bed.

In addition, one or more valves that can be controlled by means of the control and/or regulating device can be arranged in the pipes of this distribution pipe system, i.e. in the main pipe and/or the intermediate pipe and/or the longitudinal pipes and/or the standpipes. This makes it possible to advantageously and easily change the flow diameters and/or shut off individual pipe sections of the distribution pipe system, in particular to specifically influence the distribution of the materials to be discharged.

For easy removal of the dosing material, it is preferred that the at least one dosing material reservoir has a controllable dosing element as a dosing material conveying device, by means of which the dosing material can be discharged from the dosing material reservoir in a controlled manner. For a robust design, it is preferable that the controllable dosing element or the dosing material conveying device is a dosing screw. Specifically, for example, it may be further provided, alternatively or additionally, that the at least one dosing material reservoir has a dosing outlet which is connected to an inlet of the distribution system, for example to the main pipe or outflow pipe of the distribution pipe system described above, and/or in which the controllable dosing element is arranged.

For example, in connection with a particularly preferred specific embodiment, it may be provided that the at least one fermentation material conveying device is arranged at an inlet of the distribution system, in particular at an inlet of the distribution system formed by the main pipe or outflow pipe of the distribution pipe system described above. According to this particularly preferred embodiment, this pipe then forms the inlet of the distribution system, which is connected, preferably by means of a line connection, most preferably by means of a pipe connection, to a fermentation material storage reservoir and/or fermentation material reservoir arranged outside the composting basin. The dosing outlet of the dosing material reservoir is then preferably connected to the distribution system downstream of the fermentation material conveying device, particularly in the case of a common distribution system for organic fermentation material and dosing material. This results in a simple and compact design that also enables reliable operation.

For suitable process control and economical operation of the composting plant, it is preferably designed to be relatively large. According to a preferred embodiment, it is therefore provided that the composting basin has a rectangular bottom wall, in particular a rectangular base plate as bottom wall, wherein it is preferably provided that the rectangular bottom wall has a length of 50 m to 300 m, most preferably a length of 50 m to 200 m, and/or a width of 10 m to 30 m, most preferably of 10 m to 20 m, and/or that the width is spanned by the distribution system, preferably by the distribution traverse. It is further preferred that the composting basin has two longitudinal walls as side walls, whereby it is preferred that the height of the side walls is 1.5 m to 4 m, preferably 1.5 m to 3 m, so that a suitable height of the structural material bed, for example of approx. 2.0 m, can be inserted there.

Varying weather conditions, in particular rain entering the structural material bed, can disrupt the even composting process and possibly lead to a reduction in the quality of the compost. It is therefore particularly advantageous if the composting basin is located in a hall under a hall roof. If gas exchange with the environment is desired, a hall with a hall roof and hall walls that are at least partially open at the sides is advantageous. Alternatively or additionally, the composting basin can also have two end walls. Again as an alternative to this, however, the composting basin can be open on at least one end wall (preferably a wide side). This means that vehicles can then drive directly onto the bottom wall into the composting basin to introduce the structural material bed or spread the finished compost.

Precise and predeterminable metering of dosing material to the fermentation material can be achieved simply by providing a flow measuring device which is suitable and designed to measure the fermentation material flow rate when the fermentation material conveying device, for example a fermentation material pump, is activated and to feed a corresponding quantity measurement signal to a ratio controller of the control and/or regulating device, the output signal of which is the setpoint for a regulating element of the control and/or regulating device. This regulating element in turn controls, for example, a controllable dosing element forming the dosing material conveying device, which is suitable and designed to discharge dosing material from the dosing material reservoir in a predetermined ratio and, for example, ultimately to dose it into the organic fermentation material or the structural material bed. Alternatively or additionally, the regulating element can of course optionally also control the fermentation material conveying device, which is suitable and designed to discharge organic fermentation material from the fermentation material reservoir in a predetermined ratio.

The flow measuring device can be formed by a separate flow measuring device and/or by a fermentation material conveying device designed as a fermentation material pump, in which the flow rate is derived and determined from the pump speed.

Alternatively or additionally, this can also be achieved by providing a temperature measuring device which is suitable and designed to measure the temperature of the structural material in the structural material bed inoculated with or not inoculated with dosing material and to supply a corresponding temperature signal to a ratio adjuster of the control and/or regulating device, the output signal of which is the setpoint for a regulating element of the control and/or regulating device. This regulating element in turn controls, for example, a controllable dosing element forming the dosing material conveying device, which is suitable and designed to discharge dosing material from the dosing material reservoir in a predetermined ratio and, for example, ultimately to dose it into the organic fermentation material or the structural material bed.

Alternatively or additionally, the regulating element can of course optionally also control the fermentation material conveying device, which is suitable and designed to discharge organic fermentation material from the fermentation material reservoir in a predetermined ratio. The temperature can be measured, for example, using suitable temperature sensors, for example by means of sensors inserted into the bulk material or also contactlessly using infrared sensors.

Particularly in connection with the temperature measurement, it can be advantageous to divide the structural material bed into individual zones and to carry out a temperature measurement in each individual zone, for example to provide at least one temperature measuring device per zone. This type of zone-based temperature measurement can then be used to meter the dosing material as a function of the zone temperature measured in the respective zone. This allows a very precise and fine adjustment of the compost quality of the structural material bed, especially in the continuous flow process in which the bulk material is moved.

In principle, any compostable organic structural element can be used for the structural element bed, optionally as a mixture of different organic structural elements, whereby a straw bed is particularly suitable for the composting plant according to the invention and the composting process that can be carried out with it, since straw is usually available in large quantities, for example as an agricultural by-product, and is easy to handle. Accordingly, the organic structural material is formed by straw or predominantly by straw.

The organic fermentation material is preferably a liquid organic fermentation material, preferably liquid manure or predominantly liquid manure, although in principle different liquid fermentation materials can also be used. However, liquid manure is particularly suitable because it is produced in large quantities as a waste product, especially in large animal husbandry, and can be disposed of sustainably with the production of compost according to the invention.

The dosing materials can theoretically be formed by or contain any suitable macronutrient, for example carbon (C), hydrogen (H), oxygen (O), nitrogen (N), sulphur (S), phosphorus (P), potassium (K), calcium (Ca), magnesium (Mg) and silicon (Si).

Alternatively or additionally, the dosing material can be formed by or contain any suitable micronutrient, for example iron (Fe), manganese (Mn), zinc (Zn), copper (Cu) and molybdenum (Mo) as well as the non-metals chlorine (Cl) and boron (B).

Further alternatively or additionally, the dosing material may be formed by rock flour or comprise rock flour, preferably rock flour from at least one of the following source rocks:
Basalt
Diabase
Lava
Quartz
Zeolite
Granite

Further alternatively or additionally, the dosing material may be formed by or comprise microorganisms, preferably nitrogen-fixing bacteria, most preferably Azotobacter.

However, it is particularly preferred that the dosing material comprises magnesium oxide (MgO), preferably kieserite, most preferably kieserite with 20 to 30 % magnesium oxide (MgO), or is formed thereby, which can be added to a nitrogen-and phosphorus-containing organic fermentation material, preferably formed by manure, to form MAP (magnesium ammonium phosphate) or struvite. Dosing is preferably carried out in such a way that the magnesium oxide (MgO), preferably kieserite, most preferably kieserite with 20 to 30 % magnesium oxide (MgO), is added to the nitrogen-and phosphorus-containing organic fermentation material in such a way that 1 kg to 6 kg, preferably 2 kg to 5 kg, most preferably 3 kg, of dosing material is added per m3 of organic fermentation material. As the inventor's experiments have shown, the addition of kieserite to, for example, cattle or pig manure as organic fermentation material forms MAP (magnesium ammonium phosphate), also known as struvite, which is able to fix about 60 to 80% of the nitrogen in the manure or in the structural material bed, preferably a straw bed. Additional phosphorus could then be added for even more nitrogen fixation. This makes it possible to enrich the structural material bed not only with nitrogen and phosphorus, but also with magnesium by adding kieserite and to keep these elements in the structural material bed. The MAP complexes only dissolve once they have been applied to a field, for example, and worked into the soil, because the roots then create an acidic environment that not only helps the plant to absorb nutrients, but also dissolves the MAP complex. Another advantage of MAP complexes is that they are so stable that they are not washed out of the soil and therefore do not penetrate the groundwater.

A further advantage of MAP formation or MAP complexes is that the leaching of nitrate (NO3) and nitrite (NO2) in the soil can be successfully reduced or avoided, as the MAP formation means that the nitrogen is no longer freely available, but is bound in the MAP and can therefore no longer be leached out as nitrate and/or nitrite

Alternatively or additionally, the dosing material can also be formed by biochar, preferably biochar produced by pyrolytic carbonization of vegetable starting materials, preferably as charcoal, or have such a structure. In this case, the biochar acts as a kind of sponge that retains the materials in the structural material bed.

The advantages resulting from the process according to the invention are identical to those of the composting plant previously discussed in detail. In this respect reference is made to the explanations given above in order to avoid repetition.

The invention is explained further by means of a drawing.

It shows:

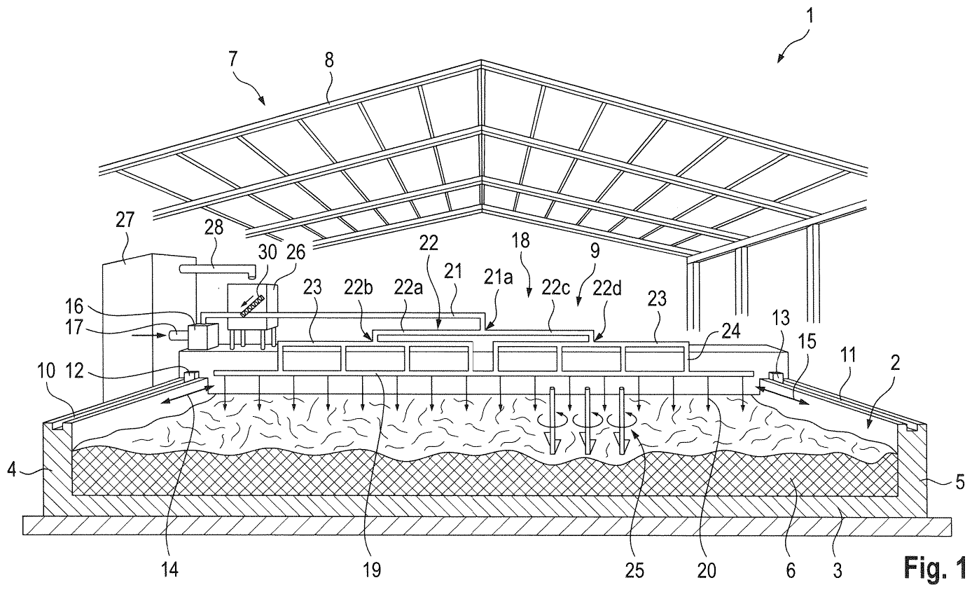

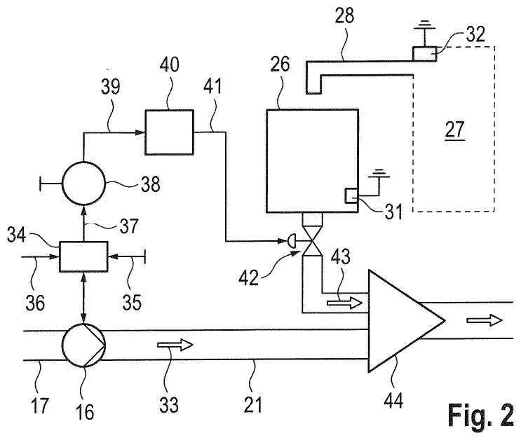

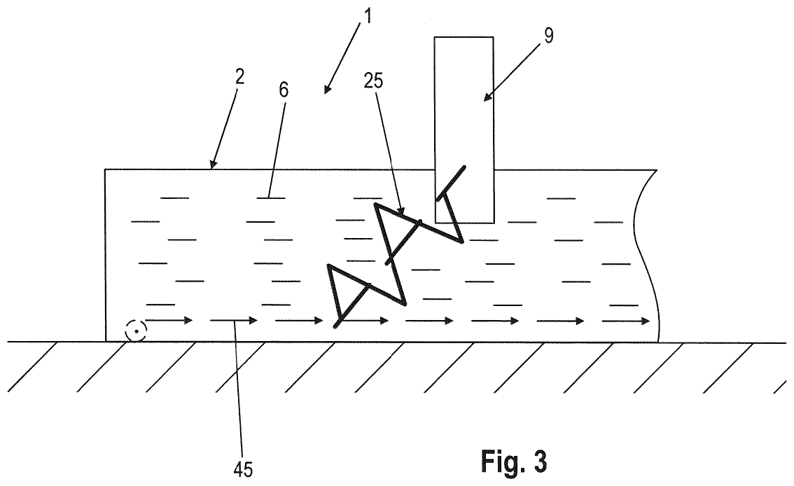

FIG. 1 a perspective, schematized view of an exemplary composting plant according to the invention in longitudinal direction FIG. 2 an exemplary schematic control unit for the composting process, and FIG. 3 schematic side view of the composting plant of FIG. 1.

In FIG. 1, a preferred embodiment of a composting plant 1 according to the invention is shown schematically in perspective and as an example in the longitudinal direction. The composting plant 1 has an upwardly open, trough-shaped, for example concreted, composting basin 2 as a composting container, which is designed with a base plate 3 as a bottom wall and which, in the present embodiment example, has a length of 200 m and a width of 20 m, for example. Furthermore, the composting basin 2 here has two side walls 4, 5, for example with a height of approx. 2 m.

In the composting basin 2, a structural material bed, in this example a straw bed 6, has already been placed with a fill height of, for example, 1.7 m above the base plate 3.

The composting plant 1, in particular the composting basin 2, is further exemplarily housed in a hall 7, with a hall roof 8 covering the composting basin 2. In the example shown here, the sides of the hall and the rear wall of the hall and/or the front wall are open.

The composting basin 2 can also be open at a front and/or rear end or wide side wall for easy bulk material transportation.

A distribution traverse 9 forms part of a distribution system (described in more detail below), exemplified here as a distribution pipe system 18. The distribution traverse 9 extends over the entire width of the composting basin 2 above the straw bed 6 and is supported here, for example, on both sides on longitudinal guide rails 10, 11 on the side walls 4, 5 by means of guide elements 12, 13, which are designed, for example, as roller or sliding elements, and can be moved forwards and backwards along the side walls 4, 5 in a controlled and motor-driven manner, as indicated by the double arrows 14, 15.

A fermentation material conveying device, for example designed as a liquid manure pump 16, is arranged on one side of the distribution traverse 9, which is connected by a pipe connection 17 to a piping connection (not shown) to a liquid manure storage tank, also not shown, as a fermentation material reservoir. In the example shown here, the liquid manure pump 16 is used to pump liquid manure, as an example of a suitable organic fermentation material, as required via the distribution pipe system 18 to an outflow pipe 19 running over the length of the distribution traverse 9 or over the width of the composting basin 2, on which outflow openings are preferably distributed over the entire length of the outflow pipe for spreading liquid manure over the preferably entire straw bedding width, as shown schematically by the outflow arrows 20. For this purpose, the outflow pipe 19 can have holes and/or slots and/or overflows as outflow openings.

To ensure that the outflow pressure to the outflow openings is as equal as possible, the distribution pipe system 18 has a main pipe 21 which is connected to the manure pump 16 and which leads approximately to the middle of the distribution traverse 9 to a first pipe branch 21a, at which an intermediate pipe 22 branches off, which extends with a first intermediate pipe part 22a again in the direction of the main pipe 21 to a second pipe branch 22b and with a second intermediate pipe part 22c in the direction away from the main pipe 21 to a third pipe branch 22d, wherein a respective longitudinal pipe 23 is connected to the second pipe branch 22b and to the third pipe branch 22c, which, in relation to the longitudinal direction of extension of the distribution traverse 9, extend over a left-and right-sided partial region of the distribution traverse 9, in this example extending over approximately one half to one third of the length of the distribution traverse 9. These longitudinal tubes 23 are then connected to the outflow pipe 19 at a distance from each other by means of standpipes 24, which in this example are vertical. In at least one part of the pipes 21, 22, 23, 24 of the distribution pipe system 18, motor-operated or manually operated valves (not shown) can also be arranged for adjustment purposes.

Mixing and stirring elements 25, in particular in the form of mixing augers and/or mixing paddles, are also arranged on the distribution traverse 9 for mixing and loosening the straw bed 6, which can be extended downwards and/or moved laterally and driven in rotation in a controlled manner, of which three mixing and stirring elements 25 are shown side by side in FIG. 1 as an example.

Furthermore, at least one, here only exemplarily exactly one, dosing material reservoir 26 is arranged on the distribution traverse 9 and can be filled and refilled with dosing material from a stationary dosing material storage reservoir 27, which is preferably much larger in comparison, via a filling pipe 28.

In this example, the dosing material reservoir 26 is connected to the main pipe 21 of the pipeline system 18 via a dosing outlet and a controllable dosing element forming a dosing material conveying device (shown here in a highly schematized form as a dosing screw 30), in this case downstream of the manure pump 16.

The dosing material reservoir 26 is filled or refilled with dosing material from the dosing material storage tank 27 using a control and regulating device (not explicitly shown), for example when the distribution traverse 9 is in a holding and rest position in the area of the dosing material storage reservoir 27, in this example only at a longitudinal end of the composting basin 2. Such a stop position can be communicated to the refill control for the dosing material via a limit switch (not shown) of the travel control for the distribution traverse 9 (also not explicitly shown). Similarly, a fill level detector 31 can be arranged in the dosing material reservoir 26, which communicates a refill request to a refill control 32 of the dosing material storage reservoir 27, in particular via radio.

FIG. 2 shows an example, simplified and schematized, of a control and/or regulating device for a predeterminable and precise addition of dosing material from the dosing material reservoir 26 to a conveyed organic fermentation material, in this case liquid manure, into the main pipe 21 of the distribution pipe system 18. This control and/or regulating device can, of course, also be the control and/or regulating device with which the distribution traverse 9 is moved in a controlled manner above the straw bed 6. Accordingly, the control and/or regulating device here is preferably suitable and designed to move the distribution traverse 9 in a controlled manner above the straw bed and simultaneously convey manure 33 by means of the manure pump 16 from a manure storage tank and dosing material 43 by means of a dosing material conveying device in a controlled manner from the at least one dosing material reservoir, which will be explained in more detail below.

Specifically, the liquid manure pump 16 is operated, for example, with an electric motor as a drive unit and a pump control 34. For a uniform application of the fermentation product, in this case liquid manure (shown schematically by arrow 33), several parameters are taken into account in the pump control 34, in particular predeterminable application quantities 35 in conjunction with driving states 36 of the distribution traverse 9. From this, a pump speed 37 is determined, with which the liquid manure pump 16 is operated depending on the process. The respective pump speed 37 can be used as a measure for the amount of liquid manure pumped. Alternatively, a separate flow measuring device can be used.

The pump speed of the manure pump 16 is fed here as a quantity measurement signal (arrow 37) to a ratio controller 38, in which the adjusted percentage dosing proportion for the dosing materials from the dosing reservoir 26 is set. A corresponding dosing quantity signal (arrow 39) is fed as a set value to a dosing controller 40, which actuates a dosing element 42 (shown here in simplified form as a control valve) with an output-side control signal (arrow 41), so that dosing material (arrow 43) is added to the manure (arrow 33) at the mixing point 44.

As can be seen only very schematically from FIG. 3, which shows a partial side view of the composting plant 1 of FIG. 1, a feed device can be provided in the composting basin 2 on the floor side, by means of which the structural material bed 6, controlled via the control and/or regulating device, can be moved along a feed device through the composting basin 2, preferably in a continuous throughput process at a feed rate of 1 to 5 meters per day. The feed device is specifically formed here by a conveyor floor 45 in the form of a conveyor belt. Alternatively or additionally, however, the feed device could also be formed by the screw conveyors forming the mixing and stirring elements 25. As shown in FIG. 3, these are then inclined towards the vertical when viewed in the conveying direction.

The dosing materials used to improve compost production and compost quality are, for example, carbon (C), hydrogen (H), oxygen (O), nitrogen (N), sulphur(S), phosphorus (P), potassium (K), calcium (Ca), magnesium (Mg) and silicon (Si) as macronutrients. Alternatively or additionally, the dosing material can be formed by at least one of the materials listed below: iron (Fe), manganese (Mn), zinc (Zn), copper (Cu) and molybdenum (Mo) as well as the non-metals chlorine (Cl) and boron (B) as micronutrients.

### Example

In a composting plant 1 as described above, 1 m3 of liquid manure was mixed with 3 kg of kieserite with 27% magnesium oxide (MgO) as dosing material and added directly to the mixing and stirring elements 25 or incorporated into the straw bedding 6 by means of these. This results in the formation of MAP (magnesium ammonium phosphate) complexes, which can be used to fix 60 to 80% of the nitrogen in the manure or straw bedding.

Composting plant 1 is designed to recycle approx. 12.5 liters of liquid fermentation material (liquid manure) per day per m3 of tank volume. With a tank length of 200 m, a tank width of approx. 20 m and a structural material dumping height of 1.7 m, this results in approx. 30,000 tons of organic fermentation material or liquid manure per year with a compost production of approx. 9,000 to 10,000 tons per year with 50 to 55% dry matter. For the above-mentioned approx. 30,000 tons per year of fermentation material, approx. 5,000 to 6,000 tons per year of structural material (straw) are consumed and approx. 9,000 to 10,000 tons per year of compost with 50 to 55% dry matter are produced.

### LIST OF REFERENCE SYMBOLS

1 Composting plant
2 Composting basin
3 Base plate
4 Side wall
5 Side wall
6 Straw fill as structural materials bed
7 Hall
8 Hall roof
9 Distribution traverse
10 Longitudinal guide rail
11 Longitudinal guide rail
12 Guide element
13 Guide element
14 Double arrows
15 Double arrows
16 Manure pump or fermentation material conveying device
17 Pipe connection
18 Distribution Pipe system or Distribution system
19 Outflow pipe
20 Outflow arrows
21 Main pipe
21a First pipe branch
22 Intermediate tube
22a First intermediate tube part
22b Second pipe branch
22c Second intermediate tube part
22d Third pipe branch
23 Longitudinal tubes
24 Standpipes
26 Dosing materials reservoir
27 Dosing material storage reservoir
28 Filling pipe
30 Dosing screw
31 Level detector
32 Refill control
33 Arrow
34 Pump control
35 Output quantity
36 Driving status
37 Arrow
38 Ratio adjuster
39 Arrow
40 Dosing regulator
41 Arrow
42 Dosing element
43 Arrow
44 Mixing point
45 Conveyor floor

1. Composting plant comprising
a structural material bed of an organic structural material, with a structural material bed of an organic structural material introduced into a composting reservoir,
at least one distribution system for an organic fermentation product and for a dosing material which differs from the organic fermentation product, it being preferably provided that the dosing material is suitable and/or designed to fix and/or bind volatile and/or leaching compounds, preferably nitrogen-containing compounds and/or phosphorus-containing compounds and/or potassium-containing compounds and/or magnesium-containing compounds and/or sulphur-containing compounds, and to retain them in the structural material bed, and
a control and/or regulating device, by means of which the at least one distribution system can be controlled in order to distribute organic fermentation product at defined times in a defined quantity and/or dosing material at defined times in a defined quantity on and/or in the structural material bed in a controlled manner.

2. Composting plant according to claim 1, wherein the at least one distribution system can be moved above the structure material bed in a controlled manner by means of the at least one control and/or regulating device.

3. Composting plant according to claim 1
wherein the at least one distribution system is connected or connectable to at least one fermentation product reservoir for organic fermentation product from which organic fermentation product can be transferred into the distribution system, and
wherein the at least one distribution system is connected or can be connected to at least one dosing material reservoir for dosing material, from which dosing material can be transferred into the distribution system.

4. Composting plant according to claim 3, wherein at least one conveying device is provided, by means of which organic fermentation product can be conveyed from the at least one fermentation product reservoir and from the at least one dosing material reservoir to the distribution system at least one fermentation product conveying device is provided, by means of which organic fermentation product can be conveyed from the at least one fermentation product reservoir to the distribution system, and at least one dosing material conveying device is provided, by means of which dosing material can be conveyed from the at least one dosing material reservoir to the distribution system.

5. Composting plant according to claim 4, wherein at least one control and/or regulating device is suitable and designed to move the distribution system above the structural material bed in a controlled manner and at the same time to convey organic fermentation product from the at least one fermentation product storage reservoir and/or dosing material (43) from the at least one dosing material storage reservoir in a controlled manner by means of the at least one fermentation product conveying device.

6. Composting plant according to claim 3 wherein a single distribution system is provided, which forms both the distribution system for organic fermentation product and for dosing material, or in that a separate distribution system is provided for organic fermentation product and dosing material respectively.

7. Composting plant according to claim 6, wherein a mixing device is provided upstream of the at least one distribution system, in which the dosing material can be added to the organic fermentation product in a predetermined ratio in a controlled manner locally upstream of and thus in advance of the feeding of the organic fermentation product to the at least one distribution system, so that a mixture of fermentation product and dosing material can be fed to the at least one distribution system.

8. Composting plant according to claim 6, wherein the at least one distribution system, has and/or forms a mixing device which is suitable and designed to add the dosing material to the organic fermentation product before, preferably directly, and/or during the application of the organic fermentation product, preferably immediately before and/or during the spreading of the organic fermentation product, in a controlled manner in a predeterminable ratio and thus to distribute a mixture of fermentation product and dosing material on and/or in the structural material bed.

9. Composting plant according to claim 6, wherein the separate distribution systems for organic fermentation product and dosing material are suitable and designed to distribute dosing material and organic fermentation product separately on and/or in the structural material bed.

10. Composting system according to claim 1 wherein the at least one distribution system has at least one distribution traverse which spans the composting reservoir and/or the structure material bed at least in some regions above the structure material bed and which can be moved above the structure material bed in a controlled manner by means of the at least one control and/or regulating device.

11. Composting plant according to claim 10, wherein a single distribution traverse is provided which has the single distribution system, or in that a plurality of distribution traverses are provided which each have a distribution system.

12. Composting plant according to claim 10,
wherein the composting reservoir has a preferably plate-shaped bottom wall and two vertical, preferably parallel side walls laterally delimiting the bottom wall, and
wherein the at least one distribution traverse is supported on both sides on longitudinal guide rails with guide elements on the side walls and can be moved along the side walls in a controlled manner.

13. Composting plant according to claim 3
wherein the at least one dosing materials reservoir is not part of the distribution system and/or is arranged in a stationary manner outside the composting reservoir, and
wherein the at least one dosing materials reservoir is connected to the distribution system by means of a pipe and/or line connection, preferably permanently and/or lockably connected.

14. Composting system according to claim 3, wherein the at least one dosing material reservoir is arranged on the distribution system so as to be movable with the distribution traverse.

15. Composting plant according to claim 14,
wherein the area outside the composting reservoir includes at least one, stationary, dosing material storage reservoir, is provided, and
wherein the distribution system, which can be moved above the structural material bed, has a controllable stop in the region of the at least one dosing material supply store at a longitudinal end of the composting reservoir, at which the dosing material storage reservoir, which can be moved along with the distribution system, can be filled from the at least one associated dosing material storage reservoir by means of at least one filling line which can be coupled to the dosing material storage reservoir.

16. Composting plant according to claim 3,
wherein at least one fermentation product storage reservoir is not part of the distribution system and/or is arranged stationary outside the composting reservoir, and
wherein the at least one fermentation product storage reservoir is connected to the distribution system by means of a pipe and/or lockable line connection.

17. Composting plant according to claim 16, wherein the at least one fermentation product storage reservoir is connected to the distribution system via at least one hose and/or pipe line so that the hose and/or pipe line has a length which is adapted to the respective travel path of the distribution system.

18. Composting plant according to claim 16 wherein a hose reel is arranged on the distribution crossbeam, which has a dimensionally stable hose that can be wound up and unwound, through which the organic fermentation product can be passed both in the rolled-up and unrolled state.

19. Composting plant according to claim 3 wherein the at least one fermentation product storage forms part of the distribution traverse so as to be movable therewith.

20. Composting plant according to claim 19, wherein the region outside the composting reservoir at least one stationary, fermentation product storage reservoir provided so that the distribution system which can be moved above the structural material bed has, at a longitudinal end of the composting reservoir, a controllable stop at which the fermentation product storage reservoir can be filled from the at least one associated fermentation product storage reservoir by means of at least one filling line which can be coupled to the fermentation product storage reservoir.

21. Composting plant according to any claim 10 wherein the distribution system is designed as a distribution pipe system, and
wherein the distribution system has at least one outflow pipe extending over at least part of the length of the distribution traverse with at least one outflow device with a plurality of outflow devices spaced apart from one another in the longitudinal direction, or wherein the distribution traverse is formed by at least one outflow pipe with at least one outflow device with a plurality of outflow devices spaced apart from one another in the longitudinal direction.

22. Composting system according claim 1, wherein the distribution system has at least one mixing and stirring element engaging in the structural material bed so that said, at least one mixing and stirring element engages in the structural material bed, preferably multiple mixing and stirring elements (25) spaced apart from each other and engaging into the structural material bed (6), and is arranged on the outflow pipe of the distribution system designed as a distribution pipe system.

23. Composting plant according to claim 22, wherein the outflow devices are at least partly suitable and designed to feed dosing material and organic fermentation product or a mixture of fermentation product and dosing material directly onto the at least one mixing and stirring element.

24. Composting plant according to claim 22 wherein the at least one mixing and stirring element is formed by a mixing screw and/or a mixing paddle.

25. Composting plant according to claim 1, wherein a feed device is provided, by means of which the structure material bed controlled via the control and/or regulating device, can be moved along a feed direction through the composting reservoir in a continuous throughput process at a feed rate is 1 to 5 metres per day.

26. Composting plant according to claim 25, wherein the feed device is formed by a conveyor floor, in particular in the manner of a conveyor belt, and/or by at least one screw conveyor simultaneously forming the mixing and stirring element.

27. Composting plant according to claim 26, wherein the at least one screw conveyor, viewed in the conveying direction, is inclined forward in the corresponding direction of rotation towards the vertical, and wherein two screw conveyors form a pair of screw conveyors in the manner of a twin-screw extruder.

28. Composting plant according to claim 21 wherein the distribution system has a main pipe, which is connected to the outflow pipe via a multiple-branching pipe system.

29. Composting plant according to claim 4 wherein the at least one dosing material reservoir has a controllable dosing element as a dosing material conveying device, by means of which the dosing material can be discharged from the dosing material reservoir in a controlled manner, wherein the controllable metering element is a metering screw; and
wherein the at least one dosing material reservoir has a metering output which is connected to an input of the distribution system (18) and/or in which the controllable metering element is arranged.

30. Composting plant according to claim 29,
wherein that the at least one fermentation product conveying device is arranged at an inlet of the distribution system, and
in that the dosing outlet of the dosing material reservoir is connected to the distribution system downstream of the fermentation product conveying device in the case of a common distribution system for organic fermentation product and dosing material.

31. Composting plant according to claim 4 wherein a flow measuring device is provided which is suitable and designed to measure the fermentation product flow rate when the fermentation product conveying device is activated and to supply a corresponding quantity measurement signal to a ratio adjuster of the control and/or regulating device, the output signal of which is the setpoint for a regulating element of the control and/or regulating device, wherein it is preferably provided that the control element controls a controllable metering element as a dosing material conveying device, which is suitable and designed to discharge dosing material from the dosing material reservoir in a predetermined ratio and/or that the control element controls the fermentation product conveying device, which is suitable and designed to discharge organic fermentation product from the fermentation product reservoir in a predetermined ratio.

32. Composting plant according to claim 4 wherein a temperature measuring device is provided which is suitable and designed to measure the temperature of the structural material in the structural material bed inoculated with or the temperature of the structural material in the structural material bed inoculated with or not inoculated with dosing material and to supply a corresponding temperature signal to a ratio adjuster of the control and/or regulating device, the output signal of which is the setpoint for a regulating element of the control and/or regulating device, it being preferably provided that the regulating element is a controllable dosing element as a dosing material conveying device which is suitable and designed to discharge dosing material from the dosing material reservoir in a predetermined ratio and/or in that the control element controls the fermentation product conveying device which is suitable and designed to discharge organic fermentation product from the fermentation product reservoir in a predetermined ratio.

33. Composting plant according to claim 1, wherein the organic fermentation product is a liquid organic fermentation product; and
wherein the organic structural material is formed or predominantly by straw.

34. Composting plant according to claim 1, wherein the dosing material comprises kieserite with 20 to 30% magnesium oxide (MgO), which can be added to a nitrogen- and phosphorus-containing organic fermentation product, preferably formed by liquid manure, to form MAP (magnesium ammonium phosphate) or struvite.

35. Composting plant according to claim 1, wherein the dosing material is formed by vegetable charcoal, produced by pyrolytic carbonization of vegetable starting materials.

36. Method for operating a composting plant, in particular for operating a composting plant comprising the steps of:
providing a structural material bed of an organic structural material, introduced into a composting reservoir,
providing at least one distribution system for an organic fermentation product
providing at least one distribution system for an organic fermentation product, and for a dosing material which differs from the organic fermentation product, so that the dosing material is suitable and/or designed to fix and/or bind volatile and/or leaching compounds, and to retain them in the structural material bed, and
providing a control and/or regulating device, by means of which the at least one distribution system is controlled in order to distribute organic fermentation product at defined times in a defined quantity and/or dosing material at defined times in a defined quantity in the structural material bed in a controlled manner.

37. Method according to claim 36, including the step of dosing the organic fermentation product and the dosing material onto and/or into the structural material bed.

38. Method according to claim 36 wherein the dosing material comprises magnesium oxide (MgO), or is formed by dosing a nitrogen- and phosphorus-containing organic fermentation product, formed by liquid manure, to form MAP (magnesium ammonium phosphate) or struvite.

39. Method according to claim 38, wherein the magnesium oxide (MgO), is a component of kieserite with 20 to 30 % magnesium oxide (MgO) and is dosed into the nitrogen- and phosphorus-containing organic fermentation product in such a way that 1 kg to 6 kg of dosing material is added per m³ of organic fermentation product.

40. Method according claim 36 further including the step of:
measuring the fermentation product flow rate by means of a separate flow measuring device when the fermentation product conveying device is activated, feeding a corresponding quantity measurement signal to a ratio adjuster, the output signal of which is the setpoint for a control element by means of which dosing material and organic fermentation product are mixed or discharged in the predetermined ratio.

41. Method according to claim 40, including the step of determining the fermentation product flow rate by means of a separate flow measuring device or by means of measuring pump speed when the fermentation product pump is activated as fermentation product feed device.

42. Method according to claim 36, including the steps of measuring the temperature of the structural material inoculated with or not inoculated with dosing material in the structural material bed can be measured by means of a separate temperature measuring device; and,
feeding a corresponding temperature measurement signal to a ratio controller, the output signal of which is the setpoint for a control element by means of which dosing material is mixed with or delivered to the organic fermentation product in the predetermined ratio.
